(19) United States
(12) Patent Application Publication
(10) Pub. No.: US 2016/0084267 A1
(43) Pub. Date: Mar. 24, 2016

(54) System Incorporating Solid Impermeable and Corrosion Resistant Barrier to Isolate Airstream and Contaminants for Air Quality and Safety

(71) Applicant: Raschid Alani Showole, Heartland, TX (US)

(72) Inventor: Raschid Alani Showole, Heartland, TX (US)

(21) Appl. No.: 14/864,803

(22) Filed: Sep. 24, 2015

Related U.S. Application Data
(60) Provisional application No. 62/054,589, filed on Sep. 24, 2014.

(51) Int. Cl. F04D 29/58; B01D 46/00

(52) U.S. Cl. CPC F04D 29/5826; B01D 46/0002

(57) ABSTRACT

A containment unit for use with hazardous materials and in heating, ventilating, and air conditioning applications has a lateral wall, a first terminal end, and a second terminal end. The lateral wall includes a lateral inner wall, a lateral insulation layer, and a lateral outer wall that form a main body and an access panel; the first terminal end and the second terminal end being adjacently connected to the main body and the access panel being removably attached to the main body. Similar to the lateral wall, the first terminal end includes a first end inner wall, a first end insulation layer, and a first end outer wall, while the second terminal end includes a second end inner wall, a second end insulation layer, and a second end outer wall. The lateral inner wall, the first end inner wall, and the second end inner wall are impermeable and corrosion resistant.

The current application claims a priority to the U.S. Provisional Patent application Ser. No. 62/054,589 filed on Sep. 24, 2014.

### FIELD OF THE INVENTION

The present invention relates generally to the containment and isolation of materials using an impermeable and corrosion resistant barrier. More specifically, the present invention provides a container having an insulation layer positioned between two walls; the inner wall being impermeable and corrosion resistant.

### BACKGROUND OF THE INVENTION

Indoor air quality is a crucial aspect of heating, ventilation and air conditioning (HVAC) systems in private homes, schools, offices, hospitals, retirement homes and other public facilities. In many healthcare facilities, for example, conditioned air that has been circulated is not usually recycled for reconditioning; instead fresh air is filtered and supplied to the evaporator of an air handling unit for conditioning so as to maintain air quality. However, the air at the upstream of the filter can still be contaminated inside the air handling unit before being delivered to the distribution ducts and the end users if the air is not isolated from insulating materials. It may be contended that the secondary air-filters in the air discharge registers at the space to be conditioned will remove any air borne particles coming from the air handling units; however, the secondary air-filters at the discharge registers are usually not of the same quality as the primary air-filter at the air intake and are not designed to hold harmful chemical contaminants that are present in many insulation materials. Furthermore reliance on the air filters also entails reliance on compliance with recommended replacement frequency for air filters.

While the air handling units of split system central air conditioner and heat pumps on the market today may be equipped with highly efficient filters, they all have common flaws because insulating materials are exposed to and have contact with the airstream.

The insulating materials may contain hazardous byproducts, and even when not substantially hazardous will become hazardous due to the micro size with which they separate from the bulk of the insulation. The micro size insulation particles could enter and contaminate the airstream thereby reducing air quality and becoming potentially harmful to end users. Therefore, there is a need for air handling equipment on the market that can isolate conditioned air from the insulating material and prevent contamination, thereby maintaining air quality.

Therefore, it is an object of the present invention to provide an air handling unit that uses an impermeable and corrosion resistant barrier, substantively or absolutely resistive of wear and tear during the life of the device, to isolate an airstream from insulation and other construction materials in order to maintain air quality. Note that equally valid would be a design for a barrier having a lifetime shorter than the life of the device but that is replaceable such that, with compliance to the recommended replacement frequency, the result would be similar to that of a system with a permanent barrier. In HVAC application, the present invention uses corrosion resistant material, such as aluminum for the inner wall of an evaporator air handling unit because despite the low humidity ratio and dryness of the cool air, the air may still condense further and forms condensate when in contact with the inner wall of the air handler. Ultimately with time the condensate could cause corrosion and deterioration of the impermeable inner wall.

It is another object of the present invention to provide a portable containment unit that uses an impermeable and corrosion resistant barrier absolutely resistive of wear and tear during the life of the device for holding or transporting hazardous materials, such as, pollutants, contaminants, and similar hazardous materials. The design and manufacture of the insulated portable containment unit will be similar to that of the air handling unit discussed above except that unlike the air handling unit, the corrosion resistant inner wall of the portable containment must be absolutely resistive of wear and tear during the life of the device and be completely sealed with no openings or leakage at the bottom and top sections. The side access door of the system shall also be tightly sealed.

### BRIEF DESCRIPTION OF THE DRAWINGS

FIG. 1 is a perspective view of a container used to store and transport hazardous materials.

FIG. 2 is a perspective view of the present invention, wherein the access panel is fully detached from the main body.

FIG. 3 is a right side sectional view of the present invention detailing the insulation layers and the impermeable and corrosion resistant inner walls.

FIG. 4 is a perspective view of a container used for heating, ventilation, and air conditioning (HVAC) applications, having a discharge opening about the top.

FIG. 5 is a perspective view of the container for HVAC applications having an intake opening about the bottom.

FIG. 6 is a perspective view of the present invention, wherein the access panel is partially detached from the main body.

FIG. 7 is a perspective view of the present invention, wherein the position of the heat exchanger and the air blower are swapped.

FIG. 8 is a right side sectional view of the present invention, detailing fluid communication between the intake opening, the interior volume, and the discharge opening, wherein an air filter is positioned within the intake opening.

### DETAIL DESCRIPTIONS OF THE INVENTION

All illustrations of the drawings are for the purpose of describing selected versions of the present invention and are not intended to limit the scope of the present invention.

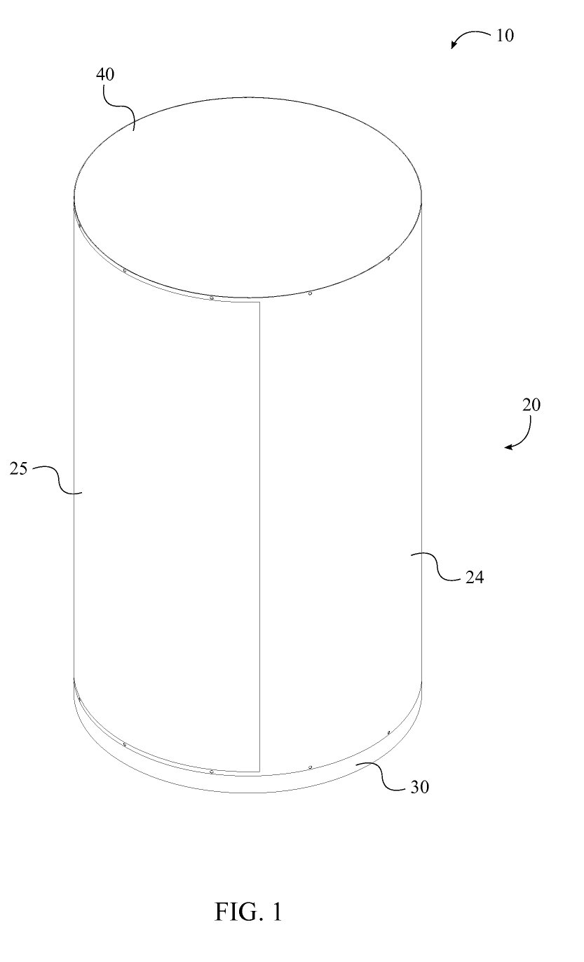

The present invention is a containment unit that can be used in both hazardous materials (HAZMAT), and heating, ventilating, and air conditioning (HVAC) applications. In reference to FIG. 1, the present invention comprises a container 10 for use in both the HAZMAT and HVAC applications, and may further comprise air handling components 60 for HVAC applications. The container 10 is an enclosure of any shape, preferably cylindrical or rectangular, and comprises a lateral wall 20, a first terminal end 30, and a second terminal end 40.

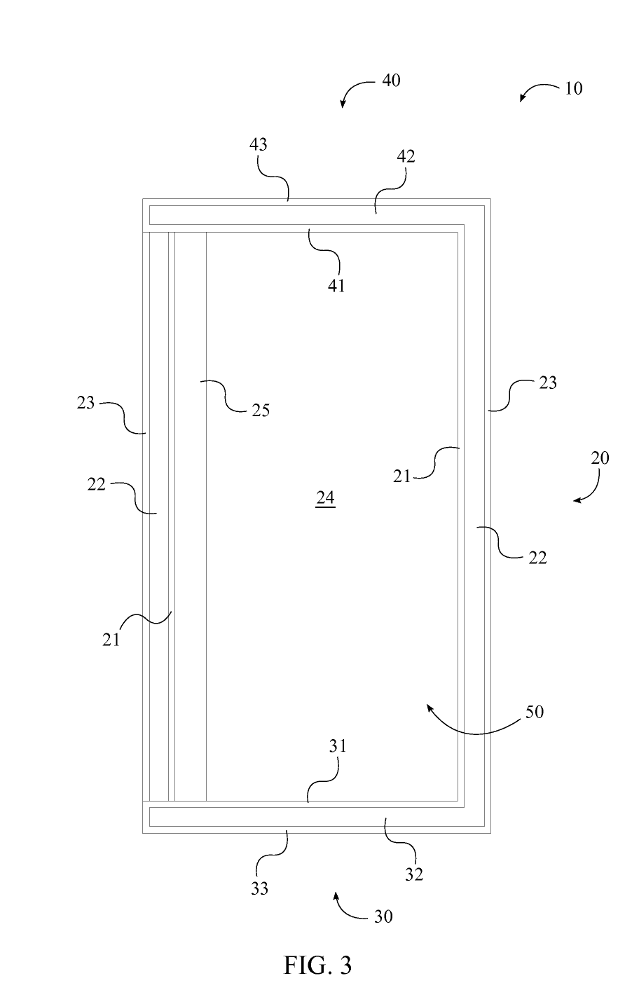

In reference to FIG. 3, the lateral insulation layer 22 is positioned in between the lateral inner wall 21 and the lateral outer wall 23, wherein the lateral wall 20 delineates the overall length and volume of the container 10. The lateral wall 20 comprises a lateral inner wall 21, a lateral outer wall 23, and a lateral insulation layer 22 that together form a main body 24 and an access panel 25, wherein the lateral insulation layer 22 is positioned in between the lateral inner wall 21 and the lateral outer wall 23. The main body 24 defines the overall shape of the container 10, while the access panel 25 provides access to the interior of the container 10.

In reference to FIG. 1, the first terminal end 30 and the second terminal end 40 form the fixed ends of the container 10; the first terminal end 30 being adjacently connected to the main body 24 and the second terminal end 40 being adjacently connected to the main body 24 opposite the first terminal end 30. The access panel 25 is positioned along the main body 24, in between the first terminal end 30 and the second terminal end 40, providing a removable side of the container 10. The access panel 25 is adjacently attached to the main body 24, such that the access panel 25 is fully or partially removable from the main body 24.

In reference to FIG. 3, similar to the lateral wall 20, the first terminal end 30 comprises a first end inner wall 31, a first end outer wall 33, and a first end insulation layer 32. The first end inner wall 31 is terminally connected to the lateral inner wall 21, while the first end outer wall 33 is terminally connected to the lateral outer wall 23; the first end insulation layer 32 being positioned in between the first end inner wall 31 and the first end outer wall 33. The first end insulation layer 32 is positioned adjacent to the lateral insulation layer 22 and may be connected to the lateral insulation layer 22 depending on the specific material used for both the first end insulation layer 32 and the lateral insulation layer 22.

In further reference to FIG. 3, similar to the first terminal end 30, the second terminal end 40 comprises a second end inner wall 41, a second end outer wall 43, and a second end insulation layer 42. The second end inner wall 41 is terminally connected to the lateral inner wall 21, while the second end outer wall 43 is terminally connected to the lateral outer wall 23; the second end insulation layer 42 being positioned in between the second end inner wall 41 and the second end outer wall 43. The second end insulation layer 42 is positioned adjacent to the lateral insulation layer 22 and may be connected to the lateral insulation layer 22 depending on the specific material used for both the second end insulation layer 42 and the lateral insulation layer 22.

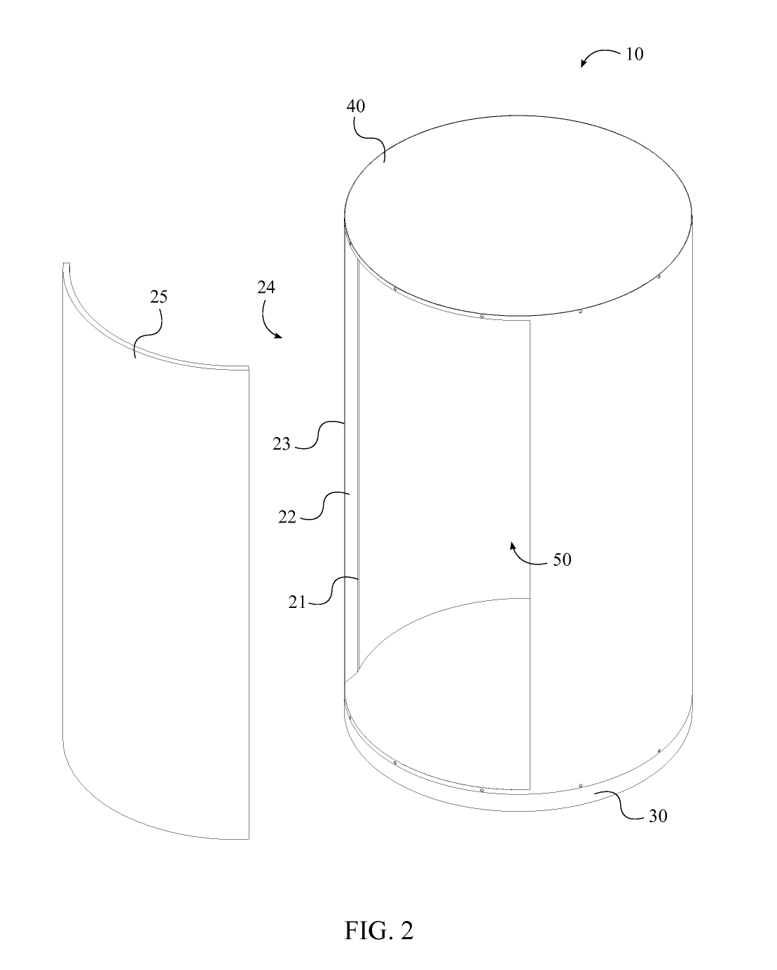

In reference to FIG. 2, the lateral inner wall 21, the first end inner wall 31, and the second end inner wall 41 delineate an interior volume 50 of the container 10 that can be used to transport HAZMAT materials or house the air handling components 60 for HVAC applications. The exact materials used may vary from application to application, however, the lateral inner wall 21, the first end inner wall 31, and the second end inner wall 41 are impermeable in all embodiments of the present invention, providing a solid barrier between the contents of the container 10 and each of the lateral insulation layer 22, the first end insulation layer 32, and the second end insulation layer 42.

For the present invention to be used in the containment of hazardous materials, the inner walls must be absolutely resistive of wear and tear during the life of the container 10. As such, for HAZMAT applications the lateral inner wall 21, the first end inner wall 31, and the second end inner wall 41 are corrosion resistant, wherein the lateral inner wall 21, the first end inner wall 31, and the second end inner wall 41 will not corrode to reveal the lateral insulation layer 22, the first end insulation layer 32, and the second end insulation layer 42 respectively. The lateral inner wall 21, the first end inner wall 31, and the second end inner wall 41 can be made to be corrosion resistant by using a naturally corrosion resistant material or by applying a process to the material.

In some embodiments of the present invention, a resin based coating is applied to the lateral inner wall 21, the first end inner wall 31, and the second end inner wall 41 in order to make the lateral inner wall 21, the first end inner wall 31, and the second end inner wall 41 corrosion resistant. Such resin based coatings include, but are not limited to, epoxies, vinyl esters, and urethanes. In other embodiments, the lateral inner wall 21, the first end inner wall 31, and the second inner wall may be constructed from a corrosion resistant material such as aluminum, stainless steel, titanium, etc. In yet other embodiments, the lateral inner wall 21, the first end inner wall 31, and the second end inner wall 41 are made to be corrosion resistant through the process of galvanization.

Furthermore, in many HAZMAT applications it is important that contents of the container 10 be sufficiently insulated from the surrounding environment. As such, the lateral insulation layer 22, the first end insulation layer 32, and the second end insulation layer 42 are made from materials having a high R-value. The lateral insulation layer 22, the first end insulation layer 32, and the second end insulation layer 42 can be constructed from a single material or an assembly of material, such as a plurality of sub layers, that result in a sufficiently high R-value.

In HAZMAT applications it is imperative that the hazardous material be isolated from the environment and each of the lateral insulation layer 22, the first end insulation layer 32, and the second end insulation layer 42. In order to ensure the isolation of the hazardous material, connections between the lateral wall 20 and each of the first terminal end 30 and the second terminal end 40 are sealed tight to prevent any gaps through which either the hazardous materials or micro particles of the material used for the lateral insulation layer 22, the first end insulation layer 32, and the second end insulation layer 42 may pass. Similarly, when the access panel 25 is attached to the main body 24, the access panel 25 and the main body 24 are sufficiently sealed in order to prevent gaps providing access to the lateral insulation layer 22.

The access panel 25 is either fully detachable, as depicted by FIG. 1-2, or partially detachable (e.g. hingedly connected along one edge and removably attached along another) from the main body 24 in order to provide access to the interior volume 50. Any type of fastening or locking mechanism can be used to secure the access panel 25 closed once the interior volume 50 has been filled with the hazardous materials. In one embodiment of the present invention, screws are used to tightly seal the access panel 25 to the main body 24 to ensure that access to the interior volume 50 is restricted.

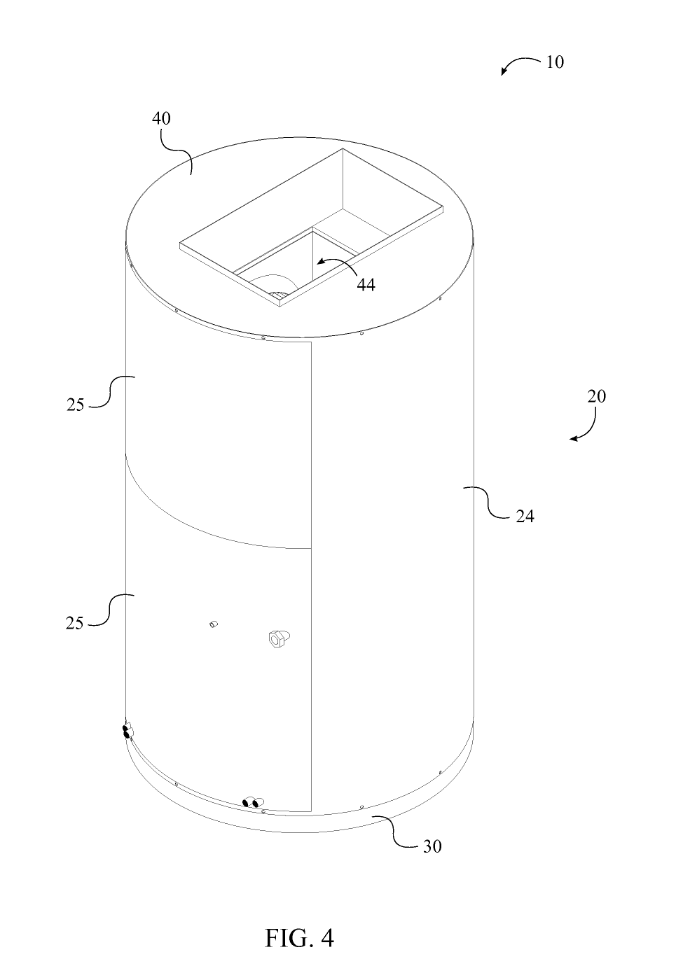

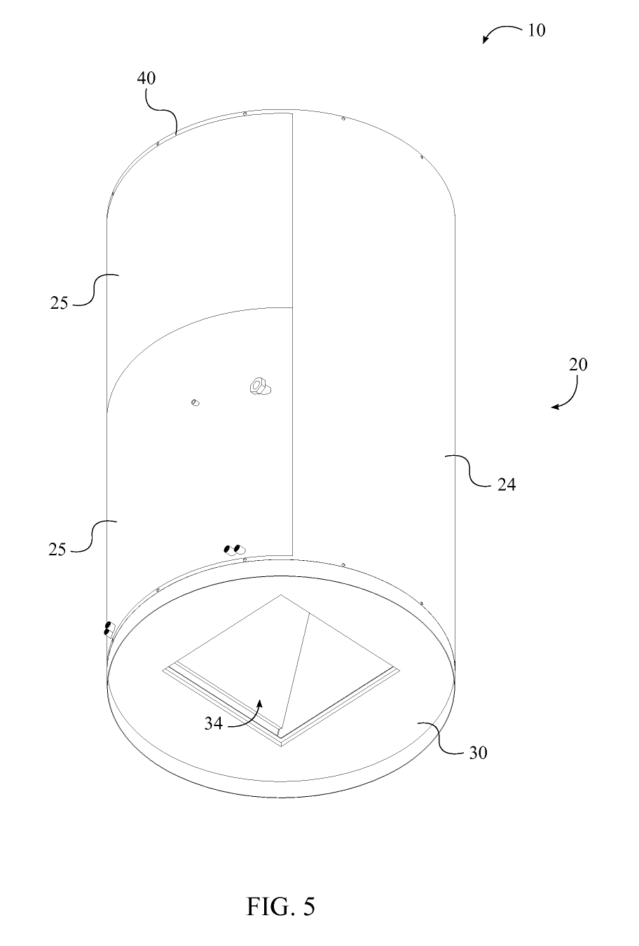

In reference to FIG. 4-5, for the present invention to be used in HVAC applications, the first terminal end 30 further comprises an intake opening 34, while the second terminal end 40 further comprises a discharge opening 44. The intake opening 34 provides a passage through the first terminal end 30, while the discharge opening 44 provides a passage through the second terminal end 40. Together, the intake opening 34 and the discharge opening 44 facilitate the flow of air through the container 10 from the first terminal end 30 to the second terminal end 40, wherein the intake opening 34 and the discharge opening 44 are in fluid communication with the interior volume 50.

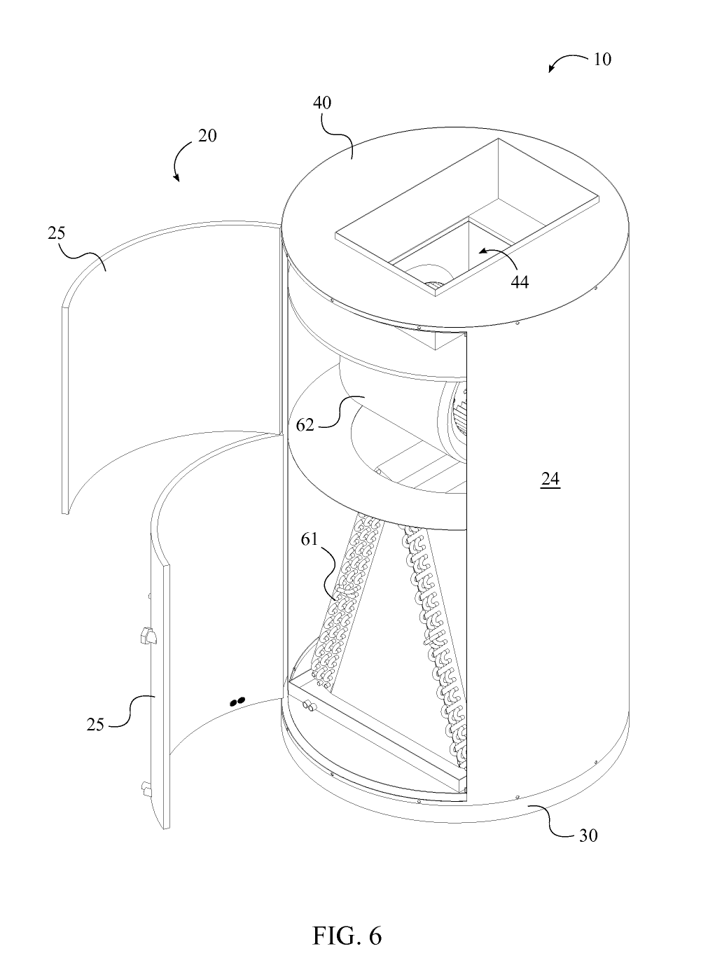

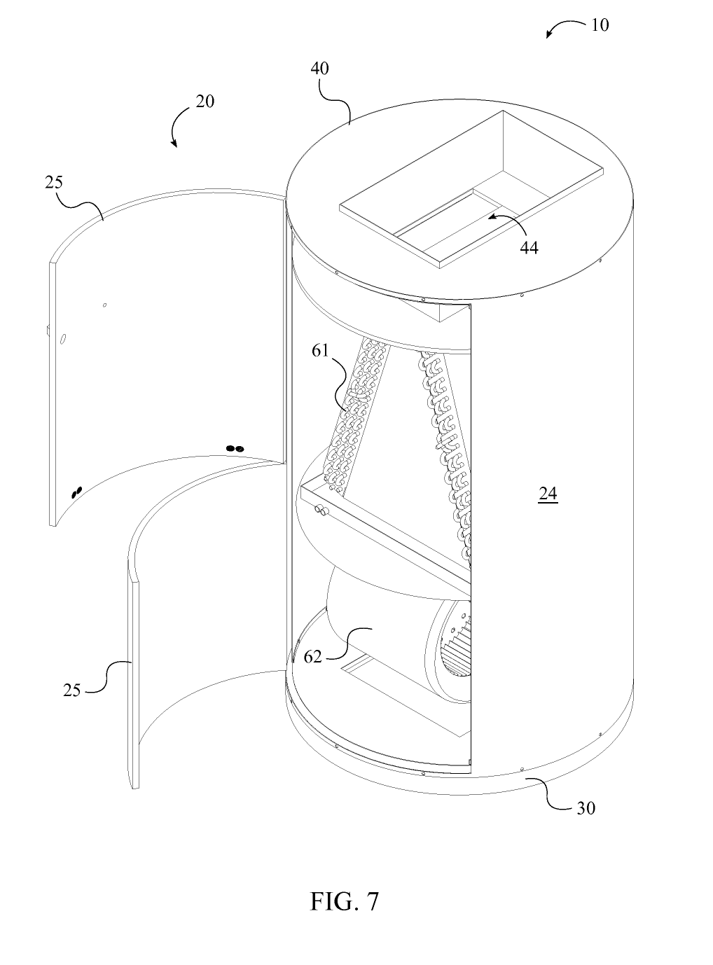

The air flow is pulled or pushed through the container 10 by the air handling components 60 positioned within the interior volume 50; the air handling components 60 comprising a heat exchanger 61 and an air blower 62. In reference to FIG. 6, the heat exchanger 61 is positioned adjacent to the intake opening 34, while the air blower 62 is positioned adjacent to the discharge opening 44. Conversely, the air blower 62 can be positioned adjacent to the intake opening 34 and the heat exchanger 61 positioned adjacent to the discharge opening 44 as depicted in FIG. 7. The air blower 62 comprises the necessary components for creating and directing an airflow including, but not limited to, a motor, blower and housing, and an air flow channel and deflector. Preferably, the heat exchanger 61 is an A-coil direct expansion heat exchanger, however, it is possible for any type of direct expansion heat exchanger to be utilized.

Air is first drawn into the container 10 by the air blower 62 through the intake opening 34. The air then passes through the heat exchanger 61 where air conditioning processes such as cooling, dehumidification, or heating take place. The processed air then exits the container 10 through the discharge opening 44 into an air transport duct.

As the air flows through the container 10, the air is isolated from the lateral insulation layer 22, the first end insulation layer 32, and the second end insulation layer 42 by the lateral inner wall 21, the first end inner wall 31, and the second end inner wall 41 respectively. The isolation of the air from the lateral insulation layer 22, the first end insulation layer 32, and the second end insulation layer 42 maintains the quality of the air, as the air is processed through the container 10. Furthermore, the lateral inner wall 21, the first end inner wall 31, and the second end inner wall 41 are corrosion resistant in order to prevent deterioration that could result in contact between the air and either the lateral insulation layer 22, the first end insulation layer 32, or the second end insulation layer 42.

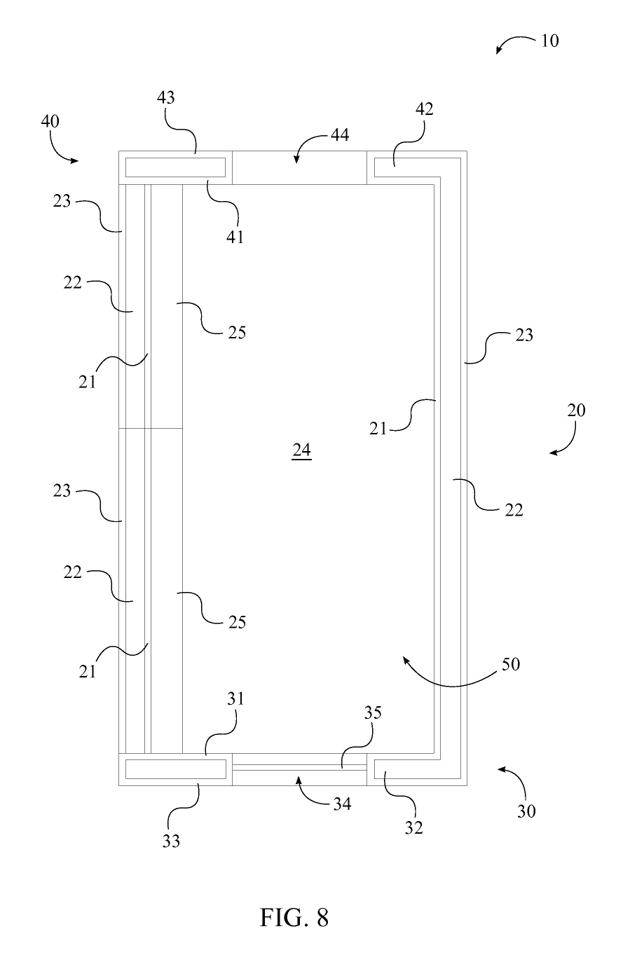

In reference to FIG. 8, the first terminal end 30 may also further comprise an air filter 35 that is used to purify the air as the air is pulled into the container 10 through the intake opening 34. As such, the air filter 35 is positioned within the intake opening 34.

The air filter 35 is removably attached to the first terminal end 30, such that the air filter 35 can be replaced as needed, according to the volume of the air being processed and the levels of pollution in the air.

In reference to FIG. 6, for HVAC applications of the present invention, the access panel 25 comprises a first door and a second door, wherein the interior volume 50 is separated into two compartments by a lower tray that is positioned within the interior volume 50 and connected to the lateral inner wall 21; the first door providing access to the heat exchanger 61 and the second door providing access to the air blower 62. The first door and the second door are either fully detachable or partially detachable (e.g. hingedly connected along one edge and removably attached along another) from the main body 24 in order to provide access to the two compartments of the interior volume 50. Any type of fastening or locking mechanism can be used to secure the first door and the second door closed. The first door and the second door allow maintenance to be performed separately on the heat exchanger 61 and the air blower 62 as needed.

Although the invention has been explained in relation to its preferred embodiment, it is to be understood that many other possible modifications and variations can be made without departing from the spirit and scope of the invention as hereinafter claimed.

What is claimed is:

1. A containment unit comprises:
a container;
the container comprises a lateral wall, a first terminal end, and a second terminal end;
the lateral wall comprises a lateral inner wall, a lateral outer wall, and a lateral insulation layer;
the lateral insulation layer being positioned in between the lateral inner wall and the lateral outer wall;
the lateral inner wall, the lateral insulation layer, and the lateral outer wall forming a main body and an access panel;
the first terminal end being adjacently connected to the main body;
the second terminal end being adjacently connected to the main body opposite the first terminal end;
the access panel being adjacently attached to the main body;
the lateral inner wall delineating an interior volume; and
the lateral inner wall being impermeable and corrosion resistant.

2. The containment unit as claimed in claim 1 comprises:
the first terminal end comprises a first end inner wall, a first end insulation layer, and a first end outer wall;
the first end inner wall being terminally connected to the lateral inner wall;
the first end outer wall being terminally connected to the lateral outer wall; and
the first end insulation layer being positioned in between the first end inner wall and the first end outer wall.

3. The containment unit as claimed in claim 2, wherein the first end inner wall is impermeable and corrosion resistant.

4. The containment unit as claimed in claim 1 comprises:
the second terminal end comprises a second end inner wall, a second end insulation layer, and a second end outer wall;
the second end inner wall being terminally connected to the lateral inner wall;
the second end outer wall being terminally connected to the lateral outer wall; and
the second end insulation layer being positioned in between the second end inner wall and the second end outer wall.

5. The containment unit as claimed in claim 4, wherein the second end inner wall is impermeable and corrosion resistant.

6. The containment unit as claimed in claim 1 comprises:
the first terminal end comprises an intake opening;
the second terminal end comprises a discharge opening; and
the intake opening and the discharge opening being in fluid communication with the interior volume.

7. The containment unit as claimed in claim 6 comprises:
a heat exchanger;
an air blower;
the heat exchanger and the air blower being positioned within the interior volume;
the heat exchanger being positioned adjacent to the intake opening; and
the air blower being positioned adjacent to the discharge opening.

8. The containment unit as claimed in claim 6 comprises:
a heat exchanger;
an air blower;
the heat exchanger and the air blower being positioned within the interior volume;
the air blower being positioned adjacent to the intake opening; and
the heat exchanger being positioned adjacent to the discharge opening.

9. The containment unit as claimed in claim 6 comprises:
the first terminal end further comprises an air filter; and
the air filter being positioned within the intake opening.

10. A containment unit comprises:
a container;
the container comprises a lateral wall, a first terminal end, and a second terminal end;
the lateral wall comprises a lateral inner wall, a lateral outer wall, and a lateral insulation layer;
the first terminal end comprises an intake opening;
the second terminal end comprises a discharge opening;
the lateral insulation layer being positioned in between the lateral inner wall and the lateral outer wall;
the lateral inner wall, the lateral insulation layer, and the lateral outer wall forming a main body and an access panel;
the first terminal end being adjacently connected to the main body;
the second terminal end being adjacently connected to the main body opposite the first terminal end;
the access panel being adjacently attached to the main body;
the lateral inner wall delineating an interior volume;
the lateral inner wall being impermeable and corrosion resistant; and
the intake opening and the discharge opening being in fluid communication with the interior volume.

11. The containment unit as claimed in claim 10 comprises:
the first terminal end further comprises a first end inner wall, a first end insulation layer, and a first end outer wall;
the first end inner wall being terminally connected to the lateral inner wall;
the first end outer wall being terminally connected to the lateral outer wall; and
the first end insulation layer being positioned in between the first end inner wall and the first end outer wall.

12. The containment unit as claimed in claim 10 comprises:
the second terminal end further comprises a second end inner wall, a second end insulation layer, and a second end outer wall;
the second end inner wall being terminally connected to the lateral inner wall;
the second end outer wall being terminally connected to the lateral outer wall; and
the second end insulation layer being positioned in between the second end inner wall and the second end outer wall.

13. The containment unit as claimed in claim 10 comprises:
a heat exchanger;
an air blower;
the heat exchanger and the air blower being positioned within the interior volume;
the heat exchanger being positioned adjacent to the intake opening; and
the air blower being positioned adjacent to the discharge opening.

14. The containment unit as claimed in claim 10 comprises:
a heat exchanger;
an air blower;
the heat exchanger and the air blower being positioned within the interior volume;
the air blower being positioned adjacent to the intake opening; and
the heat exchanger being positioned adjacent to the discharge opening.

15. The containment unit as claimed in claim 10 comprises:
the first terminal end further comprises an air filter; and
the air filter being positioned within the intake opening.

16. A containment unit comprises:
a container;
the container comprises a lateral wall, a first terminal end, and a second terminal end;
the lateral wall comprises a lateral inner wall, a lateral outer wall, and a lateral insulation layer;
the first terminal end comprises a first end inner wall, a first end insulation layer, and a first end outer wall;
the second terminal end comprises a second end inner wall, a second end insulation layer, and a second end outer wall;
the lateral insulation layer being positioned in between the lateral inner wall and the lateral outer wall;
the lateral inner wall, the lateral insulation layer, and the lateral outer wall forming a main body and an access panel;
the first terminal end being adjacently connected to the main body;
the first end inner wall being terminally connected to the lateral inner wall;
the first end outer wall being terminally connected to the lateral outer wall;
the first end insulation layer being positioned in between the first end inner wall and the first end outer wall;
the second terminal end being adjacently connected to the main body opposite the first terminal end;
the second end inner wall being terminally connected to the lateral inner wall;
the second end outer wall being terminally connected to the lateral outer wall;
the second end insulation layer being positioned in between the second end inner wall and the second end outer wall;
the access panel being adjacently attached to the main body;
the lateral inner wall delineating an interior volume; and
the lateral inner wall, the first end inner wall, and the second end inner wall being impermeable and corrosion resistant.
